(19) United States
(12) Patent Application Publication
(10) Pub. No.: US 2016/0314479 A1
(43) Pub. Date: Oct. 27, 2016

(54) TRACKING OFF-LINE COMMERCE AND ONLINE ACTIVITY

(71) Applicant: Cake Corporation, Redwood City, CA (US)

(72) Inventors: Pasan Manisha Kulasooriya, Woodside, CA (US); James B. O'Connor, San Francisco, CA (US); Jorn Wossner, San Francisco, CA (US); Shanil Fernando, Colombo (LK); Kevin En-Kai Wu, San Francisco, CA (US); Chetan Narsude, Sunnyvale, CA (US)

(21) Appl. No.: 15/204,094

(22) Filed: Jul. 7, 2016

Related U.S. Application Data
(63) Continuation-in-part of application No. 13/867,839, filed on Apr. 22, 2013, now abandoned.
Application No. 13/867,839 is a division of application No. 13/228,290, filed on Sep. 8, 2011.
(60) Provisional application No. 61/444,609, filed on Feb. 18, 2011.

(51) Int. Cl. G06Q 30/02; H04L 12/26; H04L 29/08

(52) U.S. Cl. CPC G06Q 30/0201; H04L 67/306; G06Q 30/0269; H04L 67/02; H04L 67/22; H04L 43/06

(57) ABSTRACT

Systems and methods for tracking a user's off-line commerce and merging that data with online activity are disclosed. The off-line transaction data is associated with off-line purchases of a user and includes identification information that can be used to identify the user. A scone or modified cookie is created that includes the off-line transaction data. Online activity can also be tracked and merged with the user's off-line commerce data.

### CLAIM OF PRIORITY

This application is a continuation in part of U.S. patent application Ser. No. 13/867,839, entitled “TRACKING OFF-LINE COMMERCE AND ONLINE ACTIVITY”, filed Apr. 22, 2013, which is a divisional application of U.S. patent application Ser. No. 13/228,290, entitled “TRACKING OFF-LINE COMMERCE AND ONLINE ACTIVITY”, filed Sep. 8, 2011, which claims priority to U.S. Provisional Patent Application No. 61/444,609 entitled “METHOD, SYSTEM AND APPARATUS FOR FACILITATING ONLINE TO OFFLINE COMMERCE”, filed on Feb. 18, 2011, both of which are incorporated by reference in their entirety.

### TECHNICAL FIELD

The present disclosure generally relates to the field of commerce analytics, and in particular, relates to systems, methods, and a machine readable medium for tracking off-line commerce and online activity data.

### BACKGROUND

Electronic commerce retail trade has experienced explosive growth in recent years. Online shopping is a form of electronic commerce in which consumers directly buy goods or services from a seller in real-time over the Internet. One advantage to online shopping is the ability to track a user's buying patterns and online behavior. For example, many websites keep track of consumers shopping and browsing habits using cookies in order to suggest items and other websites to view.

Cookies, also known as an HTTP cookies, web cookies, or browser cookies, are used for an origin website to send state information to a user's browser and for the browser to return the state information to the origin site. The state information can be used for authentication, identification of a user session, user's preferences, shopping cart contents, or anything else that can be accomplished through storing text data.

Traditional off-line or brick-and-mortar stores also attempt collect consumer information such as address and phone number information at checkout. However, these businesses do not have the resources or the ability to capture the multitude of online activity and offline transactions.

### BRIEF DESCRIPTION OF THE DRAWINGS

FIG. 1 depicts a block diagram of an online environment suitable for tracking off-line commerce, merging the off-line commerce data with online activity data, and determining one or more user-specific advertisements based on at least the off-line commerce data.

FIG. 2 depicts a block diagram of the components of a host server for tracking off-line commerce, merging the off-line commerce data with online activity data, and determining one or more user-specific advertisements based on at least the off-line commerce data.

FIG. 3 depicts a flow diagram illustrating an example process for creating a scone that includes off-line transaction data.

FIGS. 4A-4C depict flow diagrams illustrating example processes for receiving off-line transaction data associated with off-line transactions of a user.

FIG. 5A depicts an example credit card statement for scraping by a host server.

FIG. 5B depicts an example scone generated by scraping an example credit card statement.

FIGS. 6A-6B depict a flow diagram illustrating example operation of a host server for tracking off-line commerce, merging the off-line commerce data with online activity data, and determining one or more user-specific advertisements based on at least the off-line commerce data.

FIG. 7 depicts an example sequence diagram illustrating operation of a host server for selecting one or more user specific advertisements.

FIG. 8 is a flow diagram of a process for presenting an ad to a user at a user device based on offline and/or online transactions of the user, consistent with various embodiments.

FIG. 9 depicts a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems, methods, and a machine readable medium for tracking off-line commerce, merging the off-line commerce data with online activity data, and determining one or more user-specific advertisements to electronically deliver to the user based on at least the off-line commerce data.

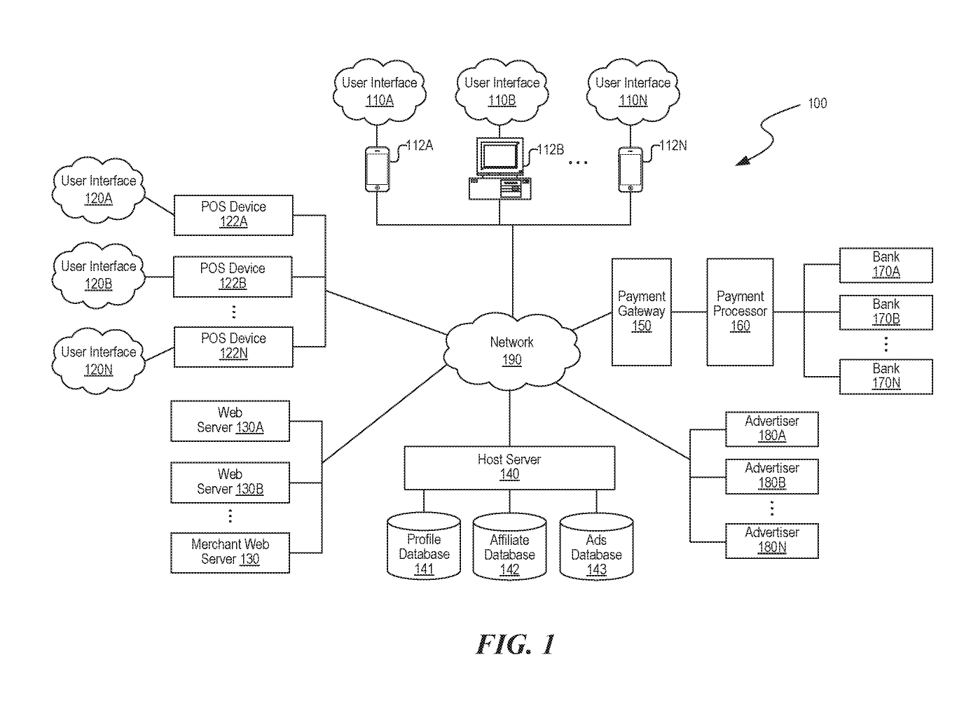

FIG. 1 depicts a block diagram of online environment 100 suitable for tracking off-line commerce, merging the off-line commerce data with online activity data, and determining one or more user-specific advertisements based on at least the off-line commerce data, according to one embodiment. Online environment 100 includes a plurality of client devices 112A-N, a plurality of point of sale (POS) devices 122A-N, a plurality of web servers 130A-N, a host server 140, data repositories 141-143, a gateway 150, a payment processor 160, a plurality of banks 170A-N, a plurality of advertisers 180A-N, and network 190.

Host server 140 is configured to communicate with client devices 112A-N, POS devices 122A-N, web servers 130A-N, banks 170A-N, and advertisers 180A-N in order to track off-line and online commerce, merge the off-line commerce data with online activity data, and/or determine one or more user-specific advertisements to electronically deliver to the users within environment 100.

The plurality of client devices 112A-N can be any system, device, and/or any combination of devices/systems that is able to establish a connection with another device, server and/or other system. The client devices 112A-N typically include respective user interfaces 110A-N. The user interfaces 110A-N include one or more input devices and a display or other output functionalities to present data exchanged between the devices to a user. For example, the client devices can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. In one embodiment, the client devices 112A-N are coupled to network 190.

In some embodiments, the client devices 112A-N can be configured to “check-in” with host server 140 to provide a communication link over which location information, etc., can be exchanged. In some embodiments, a mobile client device of devices 112A-N can be configured to “check-in” with one or more POS devices 122A-N to provide a communication link between the POS device and the client device.

The plurality of POS devices 122A-N can be any system, device, and/or any combination of devices/systems that is able to establish a connection with gateway 150 and/or other similar systems. The POS devices 122A-N typically include respective user interfaces 120A-N. The user interfaces 120A-N include one or more input devices and a display or other output functionalities to present data exchanged between the devices to a user. For example, the POS devices can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. The POS devices can also include cash drawers, receipt printers, customer displays, barcode scanners, and/or debit/credit card readers and processing systems. In one embodiment, the POS devices 122A-N are coupled to network 190.

POS devices 122A-N typically forward transaction details (e.g., purchase information) to payment gateway 150. This can be done via an SSL encrypted connection to a payment server (not shown for simplicity) hosted by the payment gateway 150, for example. In some embodiments, one or more of the plurality of POS devices 122A-N can be affiliate (e.g., modified) POS devices. Unlike non-affiliate (e.g., un-modified or standard) POS devices, affiliate POS devices can login or “check-in” with the host server 140 allowing the POS device to communicate off-line commerce or transaction information directly to the host server 140. For example, an affiliate POS device can “check-in” with the host server 140 and thereafter provide off-line purchase information directly to the host server 140 as it comes in.

The network 190, to which the client devices 112A-N and POS devices 122A-N are coupled, can be a telephonic network, an open network, such as the Internet, or a private network, such as an intranet and/or the extranet. For example, the Internet can provide file transfer, remote log in, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The network 190 can be any collection of distinct networks operating wholly or partially in conjunction to provide connectivity to the client devices 112A-N, POS devices 122A-N, web servers 130A-N, payment gateway 150, and host server 140, and can appear as one or more networks to the serviced systems and devices. In one embodiment, communications to and from the client devices 112A-N and to and from the POS devices 122A-N can be achieved by, an open network, such as the Internet, or a private network, such as an intranet and/or the extranet.

The client devices 112A-N and POS devices 122A-N can be coupled to the network (e.g., Internet) via a dial-up connection, a digital subscriber loop (DSL, ADSL), cable modem, wireless connections, and/or other types of connection. Thus, the client devices 112A-N can communicate with remote servers (e.g., web servers 130A-N, host servers, mail servers, and/or instant messaging servers) that provide access to user interfaces of the World Wide Web via a web browser, for example. Likewise, the POS devices 122A-N can communicate with remote servers (e.g., web servers 130A-N, host servers, and/or gateways) that provide access to user interfaces of the World Wide Web via a web browser, for example.

The profile database 141, affiliate database 142, and advertisements (ads) database 143 can store information such as software, descriptive data, images, system information, drivers, and/or any other data item utilized by parts of the host server 140 for operation. The profile database 141, affiliate database 142, and ads database 143 can be managed by a database management system (DBMS) such as, but not limited to, Oracle, DB2, Microsoft Access, Microsoft SQL Server, PostgreSQL, MySQL, FileMaker, etc.

The profile database 141, affiliate database 142, and ads database 143 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package. As shown, the profile database 141, affiliate database 142, and ads database 143 are coupled to host server 140. It is appreciated that, in some embodiments, the profile database 141, affiliate database 142, and ads database 143 may be directly coupled to network 190.

In some embodiments, a set of data or a profile related to a user may be stored in the profile database 141. For example, a set of data related to tracked off-line commerce of a user may be stored in profile database 141. The set of data related to the tracked off-line commerce can include off-line identification information that identifies a user. In one embodiment, host server 140 receives the set of data and builds and stores the off-line transaction data in a profile associated with the user based on the identification information. The profile indicates the off-line transaction data of the user even though the user has no affiliation (e.g., has never signed up) with the host server 140. When the user subsequently interacts with the host server 140 (e.g., signs up), the host server 140 can then correlate the profile with the user.

In some embodiments, the set of data can be stored in the profile database 141 in the form of a scone. The scone can be, for example, a modified cookie or a cookie “like” structure that includes the off-line transaction data. In some embodiments, the off-line transaction data can be layered in the scone. Alternatively or additionally, the scone can include an analysis of the off-line transaction data.

In some embodiments, information related to the various affiliates is stored in the affiliate database 142. The affiliates can be merchants that provide goods and/or services to consumers, including users of client devices 112A-N. For example, affiliates can be online retailers, bricks and clicks retailers, and/or traditional brick and mortar retailers. In some embodiments, affiliate database 142 can also include other affiliate specific information such as, for example, inventory data.

In some embodiments, a set of data related to advertisers can be stored in the ads database 143. Advertisers 180A-N can log into host server 140 and submit advertisements that can be later matched with individual users based on at least the off-line transaction data. However, in some embodiments, advertisements in the ads database 142 are matched with individual users based on both the off-line transaction data and the online activity of the user. In some embodiments, advertisers include lead generators such as, for example, Groupon and Yelp.

In some embodiments, the host server 140 is configured to track or otherwise receive off-line commerce data. For example, the host server 140 can receive off-line transaction data associated with off-line purchases of a user and create a scone that includes the off-line transaction data. The scone can be a modified cookie or a cookie “like” structure that includes the off-line transaction data. In some embodiments, the scone is dropped or otherwise transferred onto a web accessible device associated with the user. The scone can be dropped on the user accessible device associated each time that the user or client device interacts with the host server 140. In some embodiments, a scone may also be dropped on the user accessible device when the user interacts with an affiliate POS device.

The host server 140 is further configured to determine one or more user-specific advertisements to electronically deliver to the user. In some embodiments, the user specific advertisements can be selected from the advertisements in the ads database 143. In other embodiments, an advertiser may directly provide the advertisement to the user. The advertisements can be selected based on the off-line transactions data in the scone. In some embodiments, the host server 140 is further configured to track online activity of a user, merge the off-line commerce data with online activity, and determine one or more user-specific advertisements to electronically deliver to the user based on the merged off-line commerce data and the online activity data.

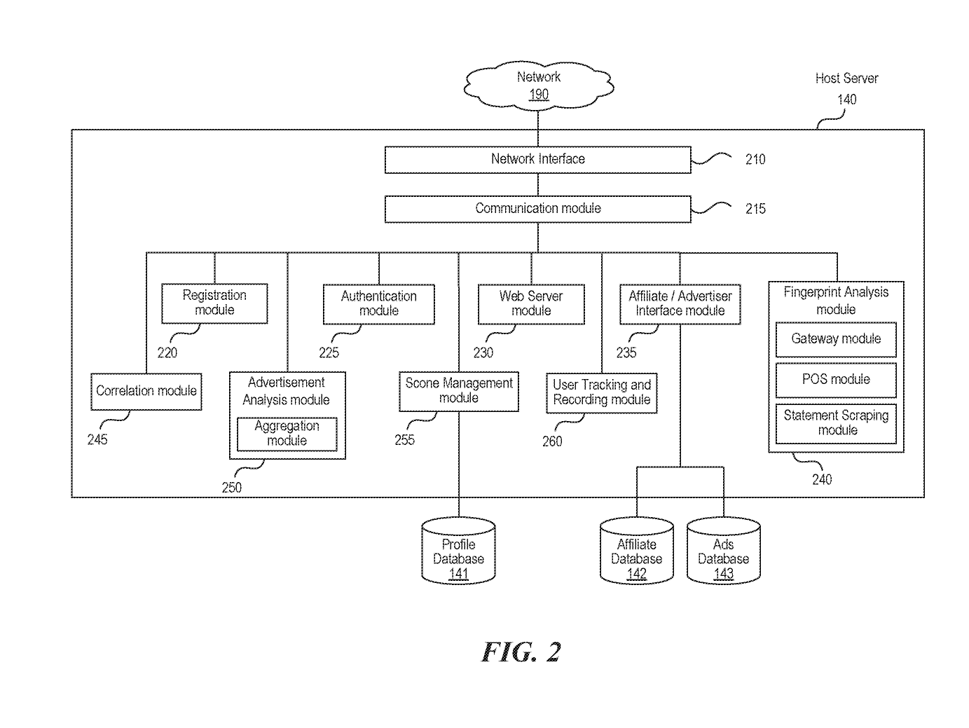

FIG. 2 depicts a block diagram illustrating an example system 200 that tracks off-line commerce, merges the off-line commerce data with online activity data, and determines one or more user-specific advertisements to electronically deliver to the user based on at least the off-line commerce data, according to one embodiment. The system includes host server 140 coupled to a profile database 141, an affiliate database 142, and an ads database 143.

The host server 140, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 2, the host server 140 includes a network interface 210, a registration module 220, an authentication module 225, a web server module 230, an affiliate/advertiser interface module 235, a fingerprint analysis module 240, a correlation module 245, an advertisement analysis module 250, a scone management module 255, and a user tracking and recording module 260. Additional or fewer modules can be included.

The host server 140 can be communicatively coupled to the profile database 141, and/or the affiliate database 142, and/or the ads database 143, as illustrated in FIG. 2. In some embodiments, the profile database 141, the affiliate database 142, and the ads database 143 are partially or wholly internal to the host server 140. In other embodiments, the profile database 141, and/or the affiliate database 142, and/or the ads database 143 are coupled to the host server 140 over network 190.

In the example of FIG. 2, the network interface 210 can be one or more networking devices that enable the host server 140 to mediate data in a network with an entity that is external to the server, through any known and/or convenient communications protocol supported by the host and the external entity. The network interface 210 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 2, the host server 140 includes the communications module 215 communicatively coupled to the network interface 210 to manage a communication session over a plurality of communications protocols. In one embodiment, the communications module 215 receives data (e.g., audio data, textual data, audio files, etc.), information, commands, requests (e.g., text and/or audio-based), and/or text-based messages over a network.

Since the communications module 215 is typically compatible with receiving and/or interpreting data originating from various communication protocols, the communications module 215 is able to establish parallel and/or serial communication sessions with users of remote client devices, affiliate POS devices, advertisers, web servers, and payment gateways.

One embodiment of the host server 140 includes a registration module 220. The registration module 220 can be any combination of software agents and/or hardware components able to register new users, affiliate POS devices, and/or advertisers with the system and/or to create new accounts with the system. In some embodiments, users provide online identification data that identifies the user when registering with the host server 140. The online identification data can then be used to correlate with off-line transaction data. In some embodiments, users may register for an account to be provided with some benefit. For example, users may register for an account with the host server so that the user can log-in or “check-in” to the host server and be provided with information such as, for example, electronic receipts from various affiliate merchants.

In some embodiments, users log-in or “check-in” with the host server 140 by first logging in to a social networking site such as, for example, Facebook, FourSquare, or Twitter. In other embodiments, a user can directly log-in or “check-in” to the host server 140. Upon receiving and authenticating the login credentials of a user, the host server 140 can then check the user in or log the user in to a variety of other social networking sites (e.g., Facebook, FourSquare, and/or Twitter). During registration the user can provide login credential for the various social networking sites that they would like to automatically log-in to upon “check-in” at the host server 140.

In some embodiments, the user's off-line transactions and online behavior can be tracked and analyzed. For example, the host server 140 tracks off-line transactions, merges the off-line transaction data with online activity data, and determines one or more user-specific advertisements to electronically deliver to the user based on the off-line commerce data and/or the online activity data. In some embodiments, a new user can be asked to consent to the tracking and recording of his user behavior. The user is informed that maintaining the user's tracking information serves to enhance the quality and relevance of the advertisements.

In some embodiments, advertisers can register for an account so that the advertisers can provide ads that will be evaluated by host server 140 in order to provide the users with the one or more user-specific advertisements. In some embodiments, the advertisers are merchants (i.e., either affiliate or non-affiliate merchants). The host server 140 can provide user-specific advertisements based on a user's off-line transactions and online activity, and thus small and medium sized businesses or merchants can direct advertisements to the customers that are most likely to patronize their establishment (off-line and/or online).

In some embodiments, a user can also check-in with the host server 140 in order to interact with an affiliate merchant POS device. For example, a user that “checks-in” with the host server 140 can inform the host server 140 when the user is at a location belonging to an affiliate merchant. The user can then be provided with a variety of information. For example, at an affiliate restaurant merchant location, a user can see what they have ordered in real-time, can be provided real-time coupons to that location or nearby locations, etc.

One embodiment of the host server 140 includes an authentication module 225. The authentication module 225 can be any combination of software agents and/or hardware components able to authenticate users, affiliate POS devices, and advertisers. In some embodiments, authentication occurs by associating a user's username and password with an existing user account and/or associating an affiliate POS device with an existing affiliate account and/or associating an advertiser's username and password with an existing advertiser account. Unauthorized users, affiliate POS devices, and/or advertisers can be directed to register with the system. In some embodiments, unauthorized advertisers can be permitted to submit advertisements without registering. However, advertisements for these unregistered advertisers may be given less priority.

One embodiment of the host server 140 includes a web server module 230. The web server module 230 can be any combination of software agents and/or hardware components able to interact with users that have logged in or otherwise interacted with the host server 140. As discussed, in some embodiments a user can “check-in” with the host server 140. For example, the user can “check-in” to the host server 140 via a web-accessible device. When the user logs in or “checks-in” via the web-accessible device, the web server module 240 interacts with the user.

In some embodiments, the web server module 230 presents one or more user-specific advertisements to a user through a web portal. In other embodiments, the web server 230 presents the one or more user-specific advertisements to a user through an affiliated POS device. For example, advertisements and/or coupons may be presented to a user via a printed receipt.

In some embodiments, the web server module 230 drops or otherwise transfers a scone on the web-accessible device when the user logs in, “checks-in,” or otherwise interacts with the host server. In some embodiments, the web server module 240 displays or electronically presents one or more user-specific advertisements to the user. Creation of the scone and determination of the one or more user-specific advertisements is discussed in more detail below with respect to the scone management module 255.

In some embodiments, the web server module 230 presents information processed by the host server 140. In some embodiments, web server module 230 provides a full service aggregated social networking site. In some embodiments, web server module 230 delivers a modular site that allows the features described herein to be integrated or embedded into another site. In some embodiments, web server module 230 delivers a platform that allows access to off-line transaction data and online activity data for each individual user.

One embodiment of the host server 140 includes an affiliate/advertiser interface module 235. The affiliate/advertiser interface module 270 can be any combination of software agents and/or hardware components able to interface with affiliate POS devices and advertisers. In some embodiments, the affiliate advertiser interface module 270 provides an interface to advertisers such as, for example, lead providers Groupon and Yelp, that allows the advertisers to store or add advertisements to the ads database 143. The affiliate/advertiser interface module 270 can also provide an interface to affiliate merchants via an affiliate POS device or other web-accessible device. In some embodiments, the affiliate POS devices may provide affiliate specific information such as, for example, inventory data.

In some embodiments, the affiliate database may also include real-time information related to the affiliate merchant that can be shared with a user via an internet accessible device once the user has logged in or “checked-in” using that device. For example, a user that has “checked-in” to an affiliate merchant's restaurant via a web accessible device can view, via the device, what the user has ordered in real-time, current deals (e.g., deals of the day at nearby locations), etc.

One embodiment of the host server 140 includes a fingerprint analysis module 240. The fingerprint analysis module 240 can be any combination of software agents and/or hardware components able to identify and analyze off-line transactions of a user or consumer using the consumer's fingerprint. The host server 140 receives or otherwise obtains or taps off-line commerce data. The fingerprint analysis module 240 is configured to receive the off-line transaction data associated with off-line transactions of a user. The off-line commerce can comprise a variety of off-line transactions of the user which can be captured or otherwise received by the host server 140 in any number of ways. The off-line commerce data includes off-line identification information such as, for example, fingerprint information that identifies a user. The fingerprint may include, but is not limited to, one or more of a credit card number, a telephone number, and/or a user attribute, for example.

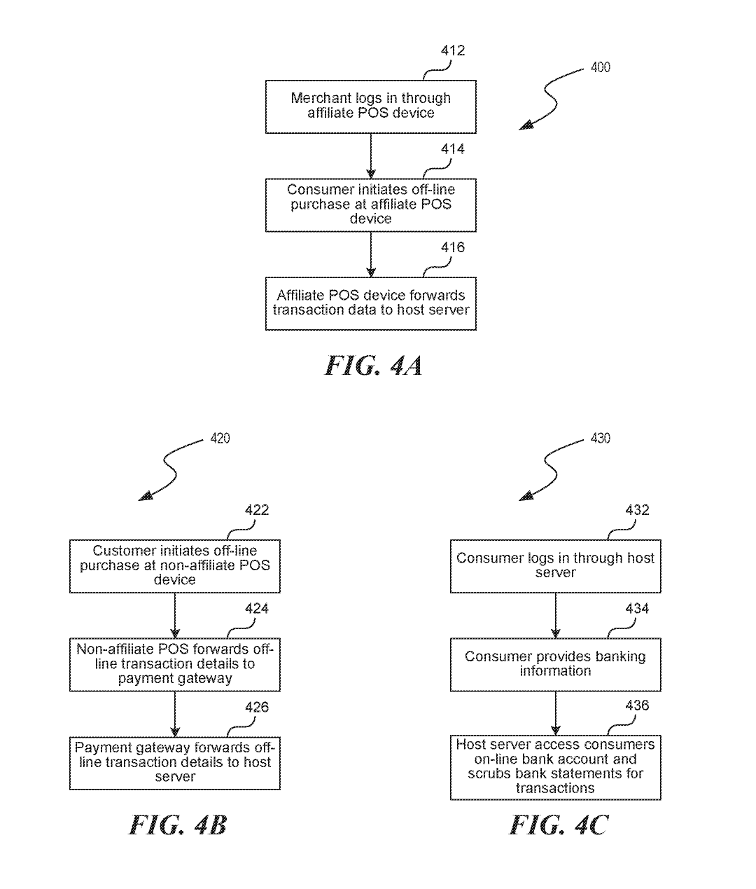

In one embodiment, the fingerprint analysis module 240 includes a gateway module, a POS module, and a statement scraping module. The gateway module receives or taps into the off-line transaction data at a payment gateway; the POS module receives or taps into the off-line transaction data at an affiliate POS device; and the statement scraping module receives or taps into the off-line transaction data at a bank server via a web-portal that provides the consumer's credit card statement online. Examples of receiving or tapping the off-line transaction data are further discussed with reference to FIGS. 4A-C.

One embodiment of the host server 140 includes a correlation module 245. The correlation module 245 can be any combination of software agents and/or hardware components able to identify off-line transaction data associated with online identification data by comparing the online identification data to the off-line identification data. For example, off-line transaction data received or tapped by the host server 140 may be stored in a profile database 141. This off-line identification data may be stored in the profile database 141 with the associated off-line identification information that identifies the user that initiated the off-line transactions. In some cases, the information is received or tapped prior to the user registering with the host server 140. In this case, the host server 140 builds a profile for the user based on the off-line identification information. Once the user registers with the host server 140, the user provides online identification information and the correlation module 245 can then associate the off-line identification information with the online identification information. Once the online and the off-line information have been associated, both the off-line transactions and the online activity may be stored together and associated with the off-line/online identification information.

One embodiment of the host server 140 includes an advertisement analysis module 250. The advertisement analysis module 250 can be any combination of software agents and/or hardware components able to determine one or more user-specific advertisements based on the off-line commerce data and/or the online activity data. In some embodiments, the advertisements analysis module 250 includes an aggregation module that aggregates the off-line transaction data and the online activity data into an aggregated data set. In some embodiments, the advertisement analysis module 250 then determines one or more user-specific advertisements based on the aggregated data set. In some embodiments, advertisement analysis module 250 accesses the of-line transaction data within a scone when the user accesses a communication network through a web-portal, and determines one or more user-specific advertisement to present to the user. The advertisements can be presented to the user through a web-portal based on the off-line transactions. In some embodiments, the web server module may deliver the advertisements over the web-portal.

One embodiment of the host server 140 includes a scone management module 255. The scone management module 255 can be any combination of software agents and/or hardware components able to create and update a scone that includes the off-line transaction data. In some embodiments, creating the scone includes embedding the off-line transaction data in a cookie or cookie “like” structure. In some embodiments, creating the scone includes embedding off-line transaction analysis in a cookie or cookie “like” structure. In this case, the off-line transaction analysis is generated by the scone management module 255 from the off-line transaction data. As shown, the scone management module 255 interfaces the profile database 141; however, other configurations are also possible.

In some embodiments, offline transaction analysis includes analyzing the offline transaction data to determine a variety of information regarding the user's offline transactions, e.g., spending pattern, spending behavior, and/or other interactions with a merchant, e.g., affiliate or non-affiliate. The analysis may include items purchased, types/categories of items purchased, frequency of purchases, times associated with purchases, purchase patterns, and/or other information gathered by a merchant location. The offline transaction data associated with a merchant may be collected based on, for example, data from credit cards, loyalty cards, coupons, mobile application-based loyalty programs. The analysis can also determine that a user shops at a high-end grocery store where he/she buys organic foods, buys more vegetables than an average consumer, shops only at a specific grocery store at a specific location, etc. Such a behavior can be derived, which otherwise is not readily available, by analyzing the actual transactions performed by the user over a predefined period of time. For example, determined based on various purchases made

One embodiment of the host server 140 includes a user tracking and recording module 260. The user tracking and recording module 240 can be any combination of software agents and/or hardware components able to monitor or track and store online activity of a user. The user activity that can be tracked can include, but is not limited to, online researching of a product or a merchant. In some embodiments, the user activity can be tracked via a tracking cookie that is dropped on a web-accessible device. In some embodiments, tracking capabilities may be included in the scone.

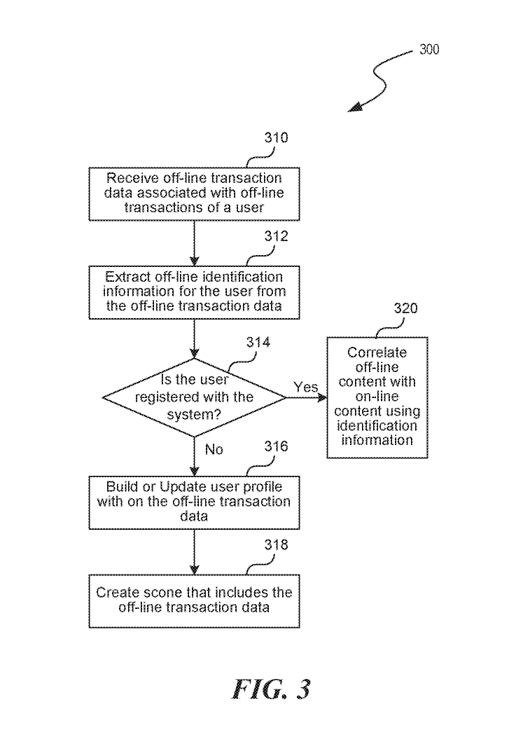

FIG. 3 depicts a flow diagram illustrating an example process 300 for creating a scone that includes off-line transaction data. In process 310, the host server 140 receives off-line transaction data associated with off-line transactions of a user. The off-line transaction data can include data associated with off-line transactions of a user occurring at affiliate and non-affiliate merchants. The off-line transaction data can include a variety of information. For example, the off-line transaction data can include, but is not limited to, one ore more of: off-line identification information that identifies the user (e.g., a customer ID); off-line identification information that identifies the merchant, off-line data that identifies an amount (e.g., amount of money changing hands during the transaction); off-line identification data that indicates the date and time the transaction occurred; off-line identification data that indicates the location of the transaction; off-line identification data that indicates the goods and/or services involved in the transaction (e.g., SKU level data); and off-line identification data that indicates whether a coupon or special promotion was involved in the transaction. The SKU level data can include, but is not limited to, itemized lists of purchased items, products, or services.

The number and type of off-line transactions received by the host server in the data can depend on the method of receiving or otherwise obtaining the off-line transaction data. For example, an affiliate merchant using an affiliate POS device may be able to provide more granular details about the transaction to a host server such as, for example, an itemized list of items purchased. The affiliate POS device can typically provide more granular details about the transaction because the affiliate POS device can communicate payment and non-payment information to the host server by logging in or to the host server. Conversely, when the host server taps, receives, or otherwise obtains off-line transaction data elsewhere, such as at the payment gateway, off-line transaction information that includes itemized lists of items purchased may not be available. Various other methods of receiving, tapping, or otherwise obtaining off-line transaction details is discussed in more detail with reference to FIGS. 4A-4C.

In process 312, off-line identification information is extracted from the off-line transaction data. The off-line identification information that identifies the user can include, but is not limited to, credit card numbers, telephone numbers, and/or any other attribute of the users (e.g., name of the customer or user). In process 314, the host server determines whether the user is registered with the system. In some embodiments, the host server determines whether the user is registered with the system by comparing online identification information (which is previously provided by the user to the host server when the user registers with the host server) to the off-line identification information gleaned from the off-line transaction data. If the online identification information provided during registration matches the off-line identification information gleaned from the off-line transaction data, then the user is registered. If the user is registered, in process 320, the host server correlates the off-line transaction data with any previously obtained online and/or off-line transaction data from the user's profile.

If the user is not registered then, in process 316, the host server builds or updates the user's profile with the off-line transaction data. The host server builds a profile for the user if a profile does not already exist. A determination about whether a profile exists can be made by comparing the off-line identification information to identification information located in other un-registered profiles. For example, the host server may compare the credit card number gleaned from the off-line identification information to credit card numbers in other un-registered profiles. If there is a match, then the un-registered profile that is matched is updated with the currently received off-line identification information. In some embodiments, the update may include adding the off-line transaction data to the un-registered profile, amending the un-registered profile to include the off-line transaction data, and/or analyzing the off-line transaction data and modifying the un-registered profile to include the analysis.

In process 318, the host server creates a scone that includes the off-line transaction data. As previously discussed, the scone may include embedding the off-line transaction data and/or analysis of the off-line transaction data in a cookie or cookie “like” structure.

FIGS. 4A-4C depict flow diagrams illustrating example processes for receiving off-line transaction data associated with off-line transactions of a user. Referring first to FIG. 4A, which illustrates process 400 of receiving, tapping, or otherwise obtaining off-line transaction data from an affiliate POS device. In process 412, the affiliate merchant logs into the host server via the affiliate POS device. In some embodiments, software or software modules operating on the POS device may direct the POS device to log in to the host server on power up, periodically, asynchronously, based on an event, or in any other manner.

In process 414, the consumer initiates an off-line transaction such as, for example, a purchase of a product or service. In process 416, the affiliate POS forwards the transaction data to the host server. Once the affiliate POS device is logged in to the host server, the affiliate POS device can share or otherwise communicate or forward off-line transaction data such as, for example, purchases, with the host device. In some embodiments, the off-line transaction data is communicated to the host server in real-time. In other embodiments, one or more off-line transactions are stored and communicated to the host server periodically and/or based on an event.

FIG. 4B illustrates the process 420 of receiving, tapping, or otherwise obtaining off-line transaction data from a payment gateway. In process 422, a customer initiates an off-line transaction at a non-affiliate POS device. In process 424, the non-affiliate POS device forwards the off-line transaction data to a payment gateway.

The payment gateway may be, for example, an e-commerce application service provider service that authorizes payments for e-businesses, online retailers, bricks and clicks, or traditional brick and mortar. The payment gateway protects transaction data by encrypting sensitive information, such as credit card numbers, to ensure that information is passed securely between merchant and the payment processor. Examples of payment gateways include, but are not limited to, First Data, Authorized.net, and Verisign. In some embodiments, the payment gateway may be a Golden retriever (which aggregates data from each payment gateway).

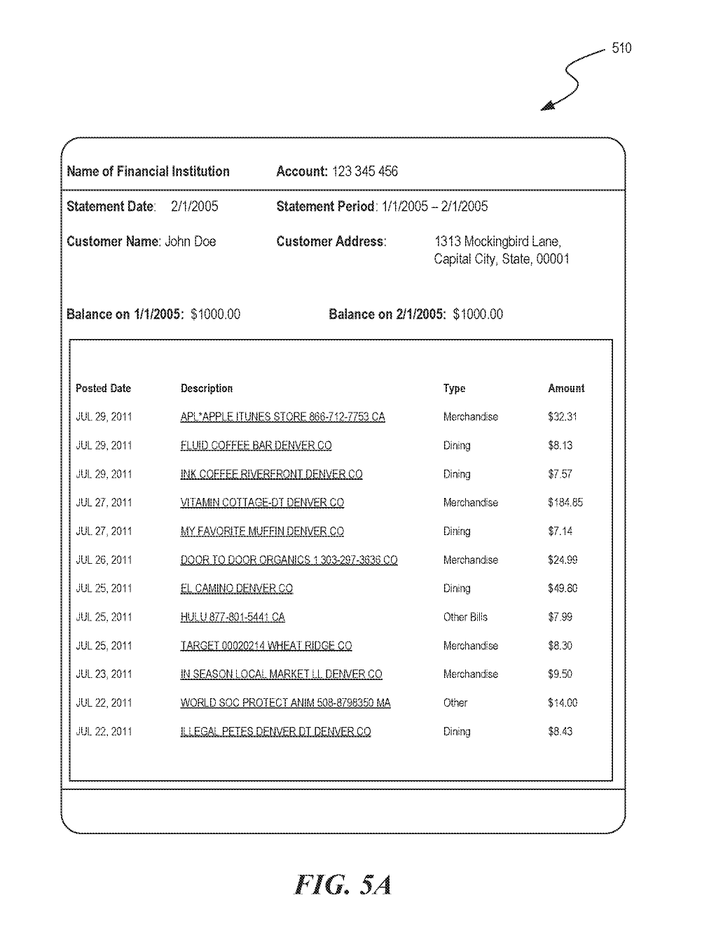

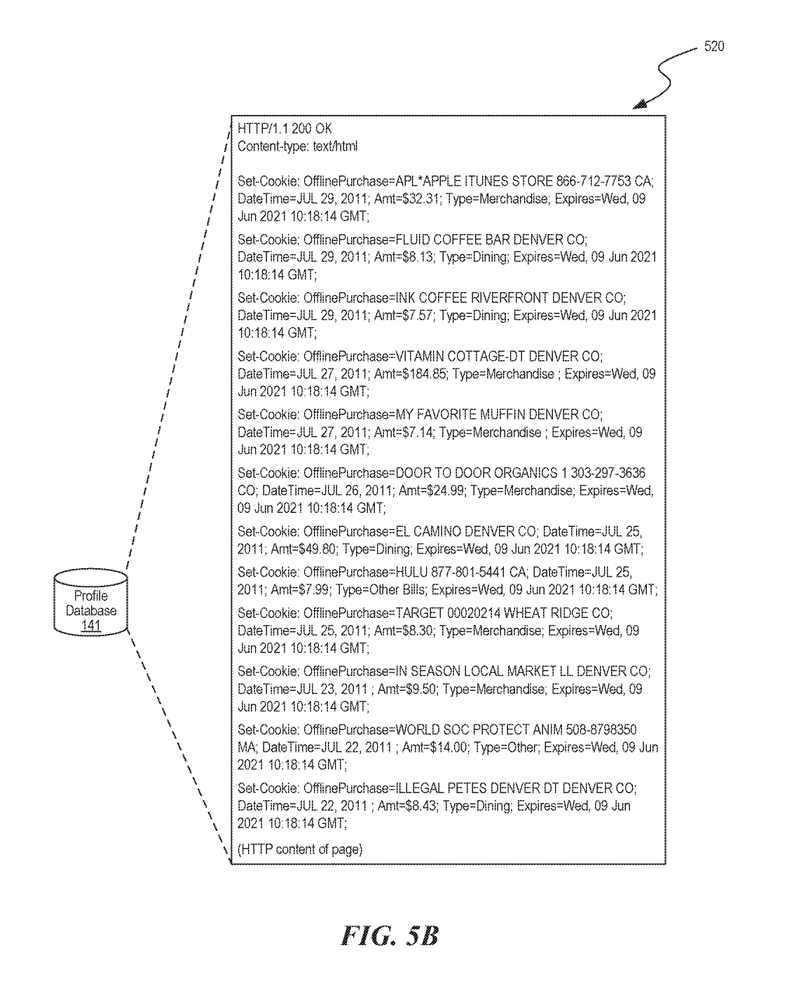

FIG. 4C illustrates the process 430 of receiving, tapping, or otherwise obtaining off-line transaction data from an online credit card statement. In particular, FIG. 4C illustrates the process of scraping off-line and/or online transaction information from a user's credit card statement. FIG. 4C is discussed with reference to FIGS. 5A and 5B. FIG. 5A illustrates an example credit card statement 510 for a user and FIG. 5B illustrates an example scone 520 generated by scraping the example credit card statement of FIG. 5A.

In process 432, a consumer logs into the host server. In process 434, the consumer provides banking information. For example, a user that registers with the host server may be asked to provide financial institution information including login credentials so that the host server can log into the financial system and extract transactional information. The transactional information may include off-line transactions and/or online transactions.

In process 436, the host server accesses consumer the consumer's online bank account and scrubs statement for transactions. As illustrated in FIG. 5A, each transaction that is scrapped from the financial system can include a multitude of information. For example, a transaction may include, but is not limited to, the date the transaction posted, a description of the transaction, a type of transaction, and an amount of money involved in the transaction.

Other information may also be gleaned from a credit card statement. For example, a user's home address may be scraped so that the host server can identify advertisements local to the user. Likewise, balance information can also be gleaned and used to identify advertisements based on the user's financial status. As discussed, FIG. 5B illustrates an example scone generated by scraping the example credit card statement of FIG. 5A. In some embodiments, the scone is stored in the profile database 141.

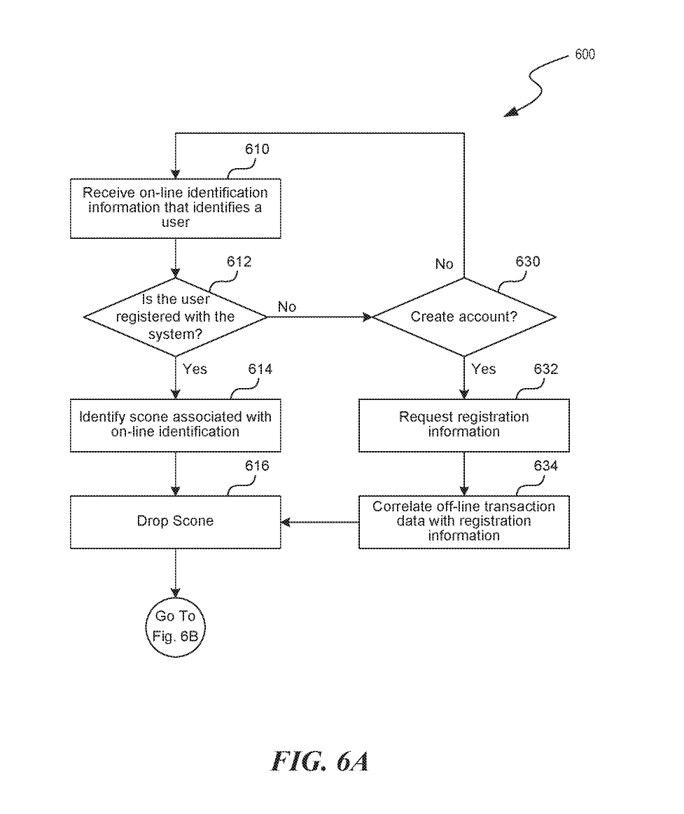

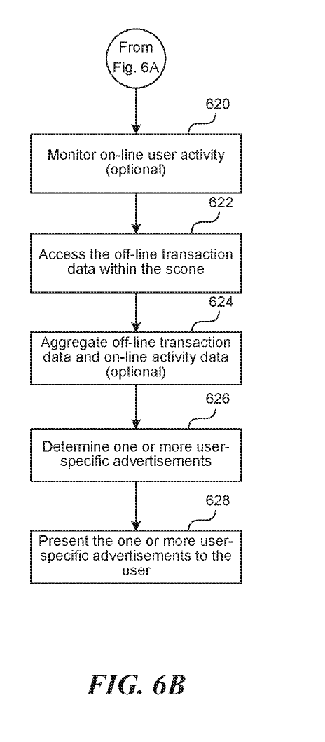

FIGS. 6A-6B depict a flow diagram illustrating an example operation of a host server, according to an embodiment. In particular, FIGS. 6A-6B illustrate the process of dropping a scone on a web accessible device associated with a user and determining one or more user-specific advertisements for the user based on at least the off-line commerce data associated with that user.

Referring first to FIG. 6A, at process 610, the host server receives online identification information that identifies a user. In some embodiments, any interaction with the host server or remote software in communication with the host server results in online identification information being received by the host server. The online identification information may include, but is not limited to, credit card numbers, telephone numbers, or other user attributes (i.e., the user's name). In some embodiments, the online identification information may be received by the host server as part of a registration process.

In process 612, the host server determines whether the user associated with the online identification information is registered with the host system. In some embodiments, the authentication process is performed each time that the host server receives online identification information associated with the user. If the user associated with the online identification information is not registered, then in process 630, the host server asks the user whether the user would like to create a new account. If the user would like to create an account, then in process 632, the host server requests registration information. Registration information may include a variety of identification information including login credentials (e.g., username/password combination), credit card numbers, telephone numbers, and/or other user attributes (i.e., the user's full name).

In process 634, the registration information and/or the received online identification information is used to correlate previously received off-line transaction data with the user. In some embodiments, the previously received off-line transaction information may have been received by tapping or otherwise obtained the off-line transaction information from an affiliate POS device or a payment gateway. In some embodiments, the previously received off-line transaction data may be stored in the profile database until the user registers with the system and the off-line transaction data is correlated with a registered user.

Referring back to process 612, if the user associated with the online identification information is registered, then in process 614, the host server identifies the scone associated with the online identification information. The online identification information can be any information that can associate a user with a scone associated with that user. For example, in some embodiments, the online identification information comprises log in credentials; however, other online identification information is also possible.

In process 616, a scone is dropped on the user's web accessible device. As previously discussed, web accessible devices can include, but are not limited to, server desktops, desktop computers, computer clusters, mobile computing devices such as a notebooks, laptop computers, handheld computers, mobile phones, smart phones, PDAs, BlackBerry™ devices, Treo™ devices, and/or iPhones, etc. In some embodiments, the scone comprises a cookie or cookie-like structure with embedded off-line transaction data. The embedded off-line transaction data comprises transactions that were previously captured by the host server and stored in a profile database.

In process 620, online activity of the user is tracked or monitored. In some embodiments, a tracking cookie is dropped in addition to the scone in order to track the online activity of the user. In some embodiments, the scone itself has the ability to track the online activity of the user. In process 622, the off-line transaction data within the scone is accessed. In some embodiments, the off-line transaction data within the scone is accessed by the host server. In some embodiments, the off-line transaction data within the scone is accessed by a merchant web server or an affiliate POS device.

In process 624, the off-line transaction data and the online activity data are optionally aggregated. In some embodiments, off-line transaction data is embedded in a scone and online activity is tracked. The off-line transaction data and the online activity can be aggregated so that the data can be processed together. In some embodiments, aggregating the data comprises analyzing the data. For example, the aggregated data may comprise an analysis of the data rather than actual online and off-line transactions.

In process 626, one or more user specific advertisements are determined. In some embodiments, the one or more user specific advertisements are determined based on the off-line transaction data. In other embodiments, the one or more user specific advertisements are determined based on the aggregated data.

Lastly, in process 628, the one or more user specific advertisements are presented to the user. The user-specific advertisements may be presented to the user in any number of ways. For example, the user-specific advertisements may be presented to the user through a web-portal or through an affiliated POS device.

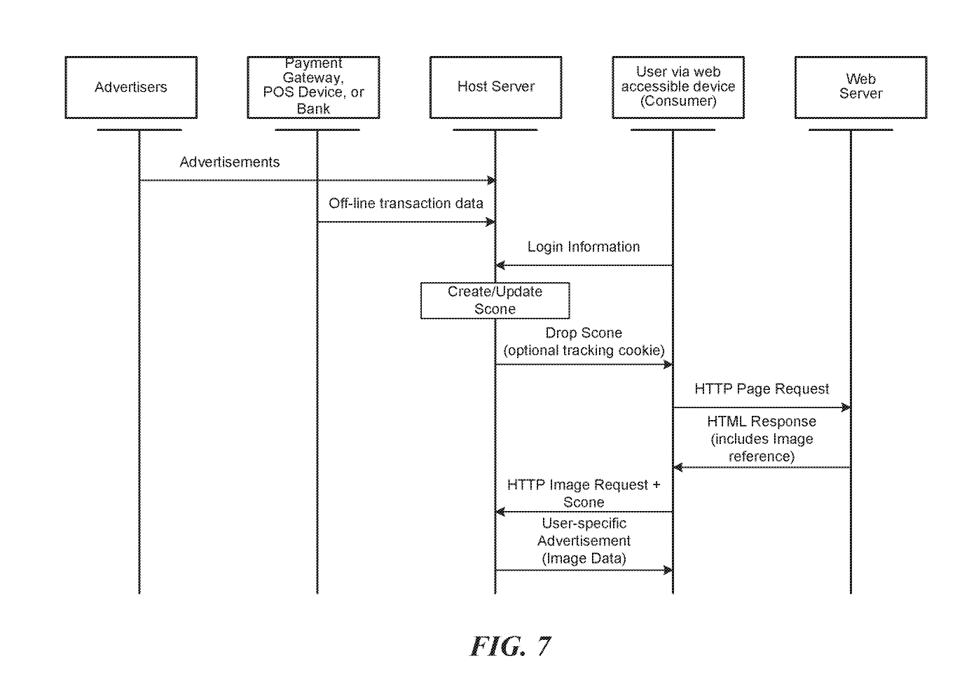

FIG. 7 depicts an example sequence diagram illustrating operation of a host server for selecting one or more user specific advertisements, according to an embodiment. As shown, advertisers first provide advertisements to the host server. In some embodiments, advertisers may provide advertisements to the host server on an ongoing basis.

The host server receives off-line transaction data from the payment gateway, an affiliate POS device, and/or by scraping bank information from a credit card statement. In some embodiments, a scone is created and/or updated upon reception of the off-line transaction information and stored in a profile database. In some embodiments, the raw data from the received off-line transaction data is stored in a profile database until login or “check-in” credentials are received from the user accessible device. As shown in this example, a scone is created or updated upon reception of the login credentials.

The scone is subsequently dropped onto the user's web accessible device. In some embodiments, the scone includes tracking abilities and/or an optional tracking cookie. In this example, the user subsequently visits a website to buy goods or services (e.g., to initiate a transaction), to conduct research, and/or for entertainment or other purposes. The web server can deliver user specific advertisements to the user in conjunction with the host server. Accordingly, when an HTTP request for a web page is received, the HTML response includes an image reference indicating the image is located on the host server. The web accessible device subsequently issues an HTTP image request to the host server that includes the scone. The host server processes the scone to identify the included off-line transactions data or analysis and determines and provides the user an advertisement based on the off-line transaction data (e.g., the prior off-line transaction data of the user). The advertisement is presented to the user in the form of an image in this example; however, advertisements may be presented to the user in any number of ways.

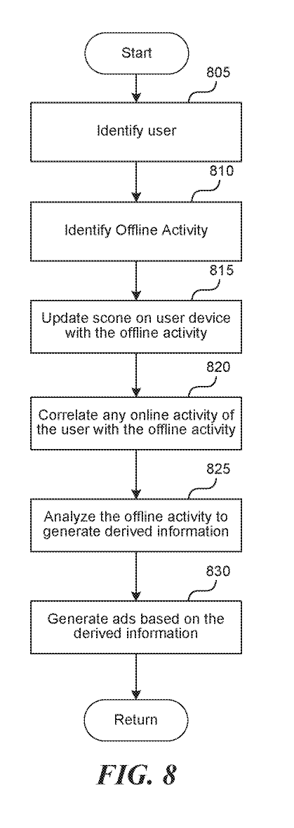

FIG. 8 is a flow diagram of a process for presenting an ad to a user at a user device based on offline and/or online transactions of the user, consistent with various embodiments. The process 800 can be implemented in the system 200 of FIG. 2. Consider that a user walks in to a merchant location, e.g., a restaurant. At block 805, the host server 140 identifies the user. The host server 140 can identify the user using one or more of multiple methods, e.g., as described with reference to FIG. 2. For example, the host server 140 can identify the user based on user's identification information provided by an application, e.g., an app associated with the host server 140, executing on a user device. The app can communicate to the host server 140 information regarding the merchant, which can be determined by the user device based on geo-fencing, GPS information, Bluetooth beacons having merchant identification information emitted by merchant devices, etc. In some embodiments, a user “checks-in” with the host server 140 can inform the host server 140 when the user is at a location belonging to an affiliate merchant. In another embodiment, the user can also sign in, e.g., using user identification information such as phone number, to a merchant device that is capable of communicating with the host server 140 regarding user identification information.

At block 810, the host server 140 identifies the offline activity of the user. In some embodiments, the offline activity can include information such as the user checked in at the merchant location. In some embodiments, the offline activity can include information regarding an offline transaction performed by the user. The offline transaction can include purchasing and/or enquiring about goods and/or services at the merchant location. For example, the offline transaction can be that the user placed an order for a burger named “Tom Brady” at the restaurant.

At block 815, the host server 140 updates the scone associated with the user with the offline activity and transmits the update or updated scone to the user device. In some embodiments, the scone is dropped at the user device when the host server 140 identifies the user. For example, when the user checks in with the host server 140, the host server 140 may transmit the scone to the user device.

At block 820, the hosts server 140 correlates online activity of the user in the scone with the identified offline activity. For example, if the scone indicates that the user had browsed a website of the restaurant to view the menu or check for specials at the restaurant, then the host server 140 can infer that a specified online activity of the user resulted into a real-world action such as the user visiting the restaurant and/or purchasing food at the restaurant. The scone provides the ability to link online activity to offline actions of the user.

At block 825, the host server 140 analyzes the offline activity to generate analytical data, e.g., additional information regarding characteristics of the user, which can be used for various purposes, e.g., in determining ads to be served to the users. For example, the analytical information can be an inference of characteristics of the user such as likes and dislikes of the user, shopping habits of the user, preferences, purchasing patterns of the user. In some embodiments, the offline transaction data in the scone can be layered, i.e., information can be stored in various levels of details. The host server 140 may have to obtain these details in order to generate the analytical data.

The host server 140 can store one or more levels of details regarding the offline transactions in the scone. In some embodiments, the host server 140 may have to obtain more details than what is stored in the scone and/or all levels of details to appropriately analyze the offline transaction data. For example, the scone may indicate that the user placed an order at the merchant location for a burger named “Tom Brady.” The merchant can be an affiliate merchant or a non-affiliate merchant. If the merchant is an affiliate merchant, the host server 140 would have normalized information associated with the merchant and the goods and/or services provided by the merchant to fit a particular taxonomy. Based on this taxonomy, the host server 140 can obtain the various layers of information. For example, the host server 140 classifies the products and services from the merchant based on the particular taxonomy so that the products and services can be easily identified by the host server 140. In some embodiments, different merchants can have different conventions for naming or classifying their products and services. Accordingly, to identify the products and services and to obtain the appropriate analytical data regarding those products and services, the host server normalizes the products and services information of various merchants based on a proprietary taxonomy so that the host server 140 can interpret those products and services appropriately. As a result of normalizing the products and services information, the host server 140 generates a set of product identification numbers (IDs) for the products and services and maps them to the product IDs of the products and services provided by the merchant. The host server 140 can then associate the additional layers of information with new product IDs.

The host server 140 can store these additional layers of information, e.g., additional information regarding a particular good and/or service, in a database associated with the host server 140, e.g., the affiliate database 142. In some embodiments, when the host server 140 receives offline transaction data of the user, the host server 140 can determine if the database has any additional layers of information associated with a particular good and/or service of the offline transaction of the user. If the database has additional layers of information, the host server 140 obtains those layers of information and performs an analysis based on the additional layers.

For example, if the scone indicates that the user placed an order for a burger named “Tom Brady” at the restaurant, the host server 140 can check a database associated with the host server 140, such as the affiliate database 142, to obtain additional layers of information for the burger. Continuing with the example, the host server 140 obtains additional information such as that “Tom Brady” is actually a Niman Ranch vegetarian burger with Swiss cheese, onions and aioli sauce on a multigrain bun. Multiple such layers of information can be stored by the host server. For example, another layer of information can be information regarding the brand of the ingredients used to make the burger, e.g., cheese of a non-premium brand vs. a premium brand. The host server 140 can obtain various such layers of information that can be used in the analysis and deriving of the analytical data regarding the user.

After obtaining the various levels of information, the host server 140 analyzes the offline activity to generate the analytical data. Continuing with above example of the burger, the host server 149 can derive information such as the user is/not a vegetarian, is/not lactose intolerant, has/doesn't have an affinity to specific food brands, e.g., of ingredients. The host server 140 can update the online profile of the user with the above analytical data.

At block 830, the host server 140 can use the online profile of the user, which includes the analytical data, for generating ads that are more customized for the user.

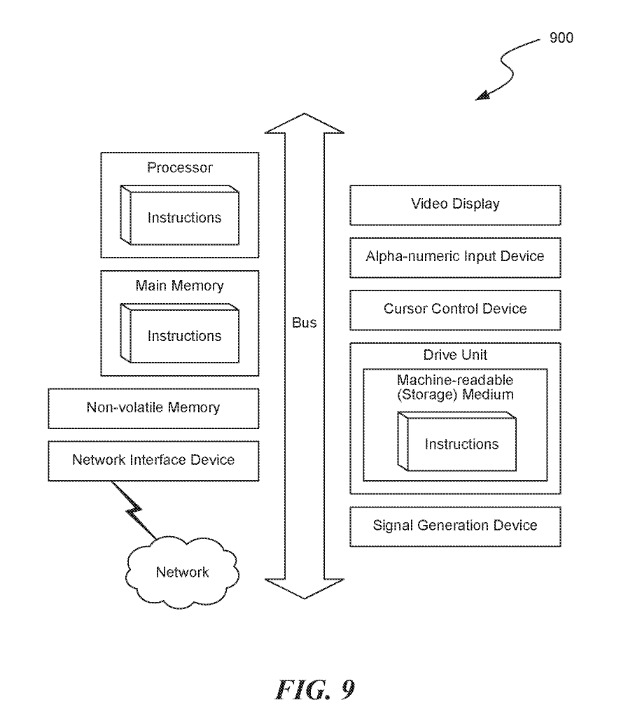

FIG. 9 shows a diagrammatic representation of a machine in the example form of a computer system 900 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (e.g., a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A computer-implemented method comprising:
receiving, at a host server in a distributed computing system, offline transaction data relating to offline purchasing activity of a user at a merchant location, the offline transaction data including offline identification information;
creating, at the host server, a scone that includes the offline transaction data of the user, wherein the offline transaction data is stored as multiple layers of information in the distributed computing system, wherein the multiple layers have different levels of detail of the offline transaction data, wherein the scone stores one or more of the multiple layers of the offline transaction data;
transmitting, by the host server, the scone to a client device associated with the user, wherein the scone tracks online activity of the user performed using the client device;
receiving, at the host server, online data relating to online activity of the user including online identification information;
analyzing, at the host server, the offline transaction data to generate analytical data regarding the offline purchasing activity, the analyzing including:
obtaining, by the host server and from a storage system associated with the host server, one or more layers of information associated with the offline purchasing activity based on the offline transaction data, and
analyzing the one or more layers of information to generate the analytical data;
updating, by the host server, the scone and an online profile of the user with the analytical data; and
transmitting, by the host server, an advertisement to the client device, the transmitting including selecting the advertisement based on the online profile and the analytical data.

2. The computer-implemented method of claim 1, wherein receiving the offline transaction data includes:
receiving, at the host server, product information of a product or a service purchased by the user at the merchant location, wherein the product information is normalized to a specified taxonomy by the host server.

3. The computer-implemented method of claim 2, wherein receiving the offline transaction data includes:
identifying, by the host server, the product based on the specified taxonomy, and
retrieving the one or more layers of information of the product from the storage system, wherein the one or more layers of information of the product are not provided as part of the offline transaction data.

4. The computer-implemented method of claim 2 further comprising:
classifying products and services from the merchant location based on the specified taxonomy, and
generating, by the host server, a first set of product identification numbers (IDs) for the products and services, wherein the first set of product IDs generated by the host server is different from a second set of product IDs of the products and services provided by the merchant location.

5. The computer-implemented method of claim 4 further comprising:
mapping, by the host server, the first set of product IDs to the second set of product IDs, and
associating, by the host server, the first set of product IDs with one or more layers of information of the corresponding products and services.

6. The computer-implemented method of claim 1, wherein analyzing the offline transaction data to generate the analytical data includes:
determining, by the host server, that the user performed the online activity for researching a product or a merchant, and
determining that the offline purchasing activity includes the user visiting the merchant, enquiring about or purchasing the product from the merchant.

7. The computer-implemented method of claim 6 further comprising:
determining, by the host server, that the offline purchasing activity resulted from the online activity of the user based on a commonality between the online activity and the offline purchasing activity, and
updating the online profile of the user to reflect a link between the offline purchasing activity and the online activity.

8. The computer-implemented method of claim 1, wherein determining that the user performed the online activity includes analyzing the scone to determine that the user accessed a website having information associated with the merchant location and/or the product.

9. The computer-implemented method of claim 1, wherein transmitting the advertisement includes:
receiving, at the host server, an indication from the client device that the user is accessing a web page at a web server, the indication including the scone and a request from the client device for an advertisement.

10. The computer-implemented method of claim 1, wherein the online profile of the user includes information regarding the offline purchasing activity and the online activity.

11. The computer-implemented method of claim 1, wherein the online activity of the user includes researching a product or a merchant.

12. The computer-implemented method of claim 1, wherein the online activity of the user includes viewing advertisements about a product or a merchant.

13. The computer-implemented method of claim 1, wherein receiving the off-line purchasing activity includes collecting the off-line purchasing activity from an online credit card statement.

14. The computer-implemented method of claim 1, wherein the off-line purchasing activity includes a customer ID, a merchant ID, a time of a purchase, data of the purchase, and an amount of the purchase.

15. The computer-implemented method of claim 1, wherein the online identification information and the off-line identification information include at least one of a credit card number or login credentials.

16. A system comprising:
a point of sale device to receive offline transaction data relating to an offline purchasing activity of a user;
a gateway system configured to receive the offline transaction data from the point of sale device; and
a host server configured to:
receive the off-line transaction data from the gateway and create a scone that includes the offline transaction data of the user, wherein the offline transaction data is stored as multiple layers of information in the system, wherein the multiple layers have different levels of detail of the offline transaction data,
transmit the scone to a client device associated with the user, wherein the scone tracks online activity of the user performed using the client device,
analyze the offline transaction data to generate analytical data regarding the offline purchasing activity,
determine a user-specific advertisement based on the analytical data, and
transmit the user-specific advertisement to the client device.

17. The system of claim 16, wherein the host server is further configured to update the scone with the analytical data.

18. The system of claim 16, wherein the host server is further configured to analyze the offline transaction data by:
obtaining, from a storage system associated with the host server, one or more layers of information associated with the offline purchasing activity based on the offline transaction data, and
analyzing the one or more layers of information to generate the analytical data.

19. The system of claim 16, wherein the point of sale device is further configured to:
receive a request from the user to deliver an electronic receipt via e-mail, and
upon receiving the request, access the host server to receive a user-specific advertisement to be embedded within the receipt.

20. The system of claim 16, wherein the scone is dropped on the client device through a web portal.

21. A computer-readable storage medium storing computer-readable instructions, comprising:
instructions for receiving, at a host server in a distributed computing system, offline transaction data relating to offline purchasing activity of a user at a merchant location, the offline transaction data including offline identification information;
instructions for creating, at the host server, a scone that includes the offline transaction data of the user, wherein the offline transaction data is stored as multiple layers of information in the distributed computing system, wherein the multiple layers have different levels of detail of the offline transaction data, wherein the scone stores one or more of the multiple layers of the offline transaction data;
instructions for transmitting, by the host server, the scone to a client device associated with the user, wherein the scone tracks online activity of the user performed using the client device;
instructions for receiving, at the host server, online data relating to online activity of the user including online identification information;
instructions for analyzing, at the host server, the offline transaction data to generate analytical data regarding the offline purchasing activity, the analyzing including:
obtaining, by the host server and from a storage system associated with the host server, one or more layers of information associated with the offline purchasing activity based on the offline transaction data, and
analyzing the one or more layers of information to generate the analytical data;
instructions for updating, by the host server, the scone and an online profile of the user with the analytical data; and
instructions for transmitting, by the host server, an advertisement to the client device, the transmitting including selecting the advertisement based on the online profile and the analytical data.

22. The computer-readable storage medium of claim 21, wherein the instructions for receiving the offline transaction data include:
instructions for receiving, at the host server, product information of a product or a service purchased by the user at the merchant location, wherein the product information is normalized to a specified taxonomy by the host server.

23. The computer-readable storage medium of claim 22, wherein the instructions for receiving the offline transaction data include:
instructions for identifying, by the host server, the product based on the specified taxonomy, and
instructions for retrieving the one or more layers of information of the product from the storage system, wherein the one or more layers of information of the product are not provided as part of the offline transaction data.

24. The computer-readable storage medium of claim 22 further comprising:
instructions for classifying products and services from the merchant location based on the specified taxonomy, and
instructions for generating, by the host server, a first set of product identification numbers (IDs) for the products and services, wherein the first set of product IDs generated by the host server is different from a second set of product IDs of the products and services provided by the merchant location.

25. The computer-readable storage medium of claim 24 further comprising:
instructions for mapping, by the host server, the first set of product IDs to the second set of product IDs, and
instructions for associating, by the host server, the first set of product IDs with one or more layers of information of the corresponding products and services.

26. The computer-readable storage medium of claim 21, wherein the instructions for analyzing the offline transaction data to generate the analytical data include:
determining, by the host server, that the user performed the online activity for researching a product or a merchant, and
determining that the offline purchasing activity includes the user visiting the merchant, enquiring about or purchasing the product from the merchant.

27. The computer-readable storage medium of claim 26 further comprising:
instructions for determining, by the host server, that the offline purchasing activity resulted from the online activity of the user based on a commonality between the online activity and the offline purchasing activity, and
instructions for updating the online profile of the user to reflect a link between the offline purchasing activity and the online activity.
